(19) United States
(12) Patent Application Publication
(10) Pub. No.: US 2008/0006654 A1
(43) Pub. Date: Jan. 10, 2008

(54) Caulk gun with cutter

(76) Inventors: John K. Lampe, St. Paul, MN (US); Douglas R. Oudekerk, St. Paul, MN (US)

Correspondence Address: John K. Lampe, 262 Griggs Street South, St. Paul, MN, 55105, US

(21) Appl. No.: 11/824,848

(22) Filed: Jul. 3, 2007

Related U.S. Application Data
(60) Provisional application No. 60/819,060, filed on Jul. 7, 2006.

(51) Int. Cl. B67D 5/00; G01F 11/00

(52) U.S. Cl. 222/80; 222/386

(57) ABSTRACT

The invention can be a device for dispensing flowable materials such as caulk. A first embodiment comprises a cartridge and a dispenser with a drive mechanism for advancing a pusher forward, the drive mechanism having at least one fulcrum positioned forward of the pusher during operation of the dispenser. A second embodiment comprises a cartridge and a dispenser having a cutter that cuts a slit in a wall of the cartridge for purposes of dispensing a flowable material. A third embodiment comprises a dispenser having a drive mechanism with a winch for driving the dispensing of a flowable material from a cartridge.

This application claims the benefit of U.S. Provisional Application Nos. 60/819,060 filed on Jul. 7, 2006.

### FIELD OF THE INVENTION

The present invention generally relates to a dispenser for substances such as caulk. Specifically, it can relate to a dispenser with a cutter for cutting a seam in a cartridge containing a flowable substance to aide in dispensing the substance.

### BACKGROUND OF THE INVENTION

Dispensers such as caulk guns are well known in the art. Most conventional caulk guns use a disposable cartridge. The cartridge includes a tube that is pre-filled with material such as caulk. The cartridge has a nozzle on the front end. The caulk is typically sealed in the cartridge by a frangible seal on the front end of the tube and a cartridge piston inside the tube near the back end of the cartridge.

Typically a user prepares the cartridge for use by cutting off the tip of a nozzle to create an opening in the nozzle of the desired shape and size. The user pierces the front seal through the opening in the nozzle and loads the cartridge into the dispenser. With a trigger mechanism, the user advances a pusher rod having a pusher on the front end into the back end of the tube to bring the pusher in contact with the cartridge piston. Caulk is expelled from the cartridge by pushing the cartridge piston forward.

The prior art offers many variations on dispensers such as those for dispensing caulk. However, the prior art dispensers still suffer from certain shortcomings or limitations. The purpose of the present invention is to overcome these and other shortcomings or limitations in the prior art.

### SUMMARY OF THE INVENTION

The present invention generally relates to a dispenser of a kind that could be used to dispense caulk and other materials. In at least one embodiment, the dispenser comprises a pre-filled cartridge of a kind known in the art for containing caulk; a pusher, a connecting member, and a drive mechanism. The connecting member can connect the pusher to the drive mechanism. In addition the connecting member can have a cutter. The cutter can be positioned on the front edge of the connecting member. When the drive mechanism moves the connecting member forward, the cutter on its front edge can cut a longitudinal seam in the cartridge tube starting from the back end of the tube. Simultaneously, the connecting member moves the pusher forward inside the cartridge tube. As the drive mechanism moves the pusher forward, the pusher eventually contacts the cartridge piston and starts to expel the caulk. The drive mechanism can continue to move the connecting member forward in the seam created by the cutter until the pusher has expelled virtually all the caulk or other substance in the cartridge tube.

The above summary of the present invention is not intended to describe each illustrated embodiment, object, advantage, or use of the present invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1A is a side view in slight perspective of a dispenser loaded with a cartridge according to a first embodiment of the invention.

FIG. 1B is a back view of a dispenser loaded with a cartridge according to a first embodiment of the invention.

FIG. 1C is a front view of a dispenser loaded with a cartridge according to a first embodiment of the invention.

FIG. 1D is a perspective, exploded view of the back end of a dispenser according to a first embodiment of the invention.

FIG. 1E is a perspective view of the back end of a dispenser loaded with a cartridge whose wall is being cut by a cutter according to a first embodiment of the invention.

FIG. 1F is a perspective view of the back end of a dispenser loaded with a cartridge whose wall is being cut by a cutter and the pusher has entered the cartridge tube according to a first embodiment of the invention.

### REFERENCE NUMERALS IN DRAWINGS

100 dispenser
101 cartridge
102 cartridge tube
103 nozzle
104 front end of cartridge and dispenser
105 back end of cartridge and dispenser
106 cartridge piston
107 handle
108 cradle
109 pusher
110 drive mechanism
111 trigger
112 winch
113 cable
114 pulleys
115 slider
116 guide
117 slot in guide
118 connecting member
119 cutter
120 front edge of cutter
121 wall of cartridge tube
122 seam
123 pusher face
124 retainer
125 retainer pivot
126 second position of retainer
127 release lever
128 clockwise direction
129 counterclockwise direction
130 winch drum
131 trigger in second position (fully compressed or pulled)

### Detailed Description of the Invention Including a Best Mode

As disclosed the invention concerns a dispenser that could, among other things, dispense caulk. However, the invention is not limited to such uses. The structure of the dispenser may be useful for other purposes. Other purposes might include, for example, dispensing pasty substances for cooking or baking, dispensing adhesives, dispensing other flowable substances, or for any other use where such a structure might be usable and beneficial. The invention should be understood to encompass these other uses although such other uses may not be discussed below.

### First Embodiment

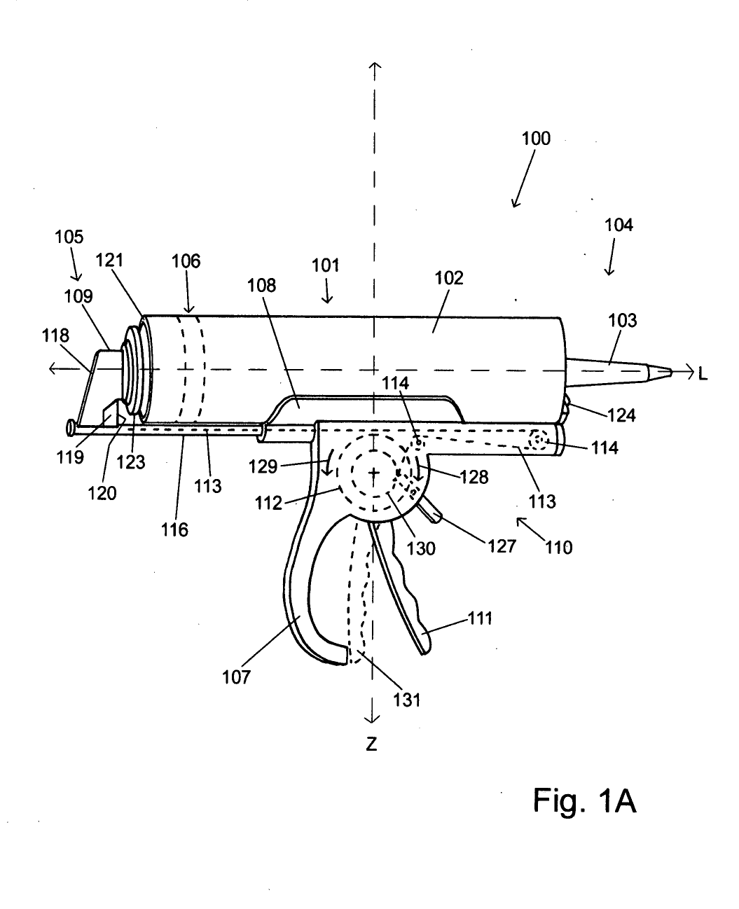

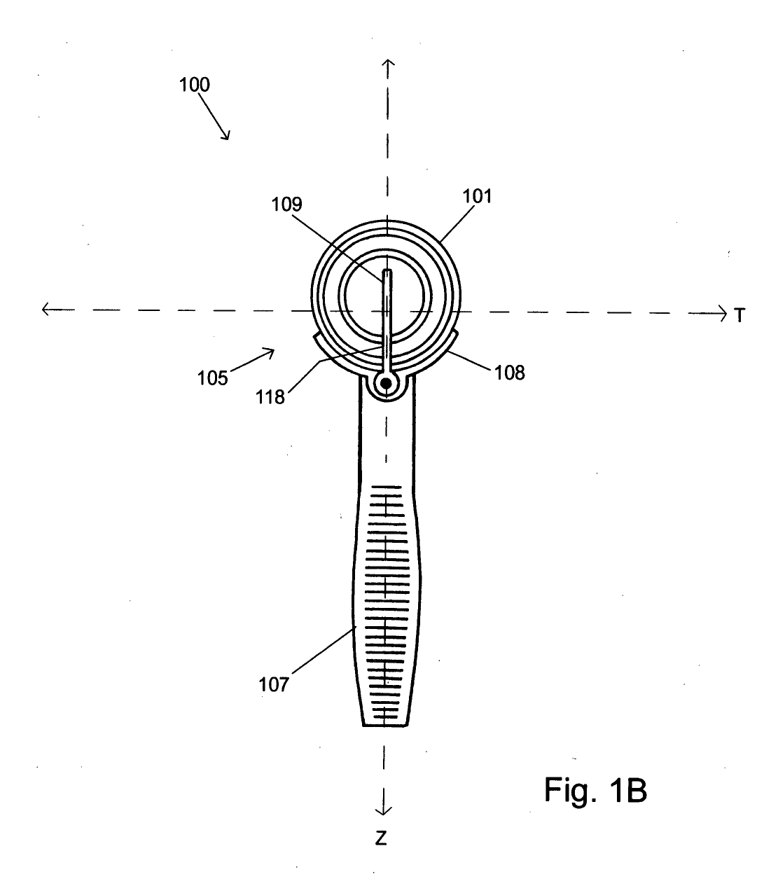

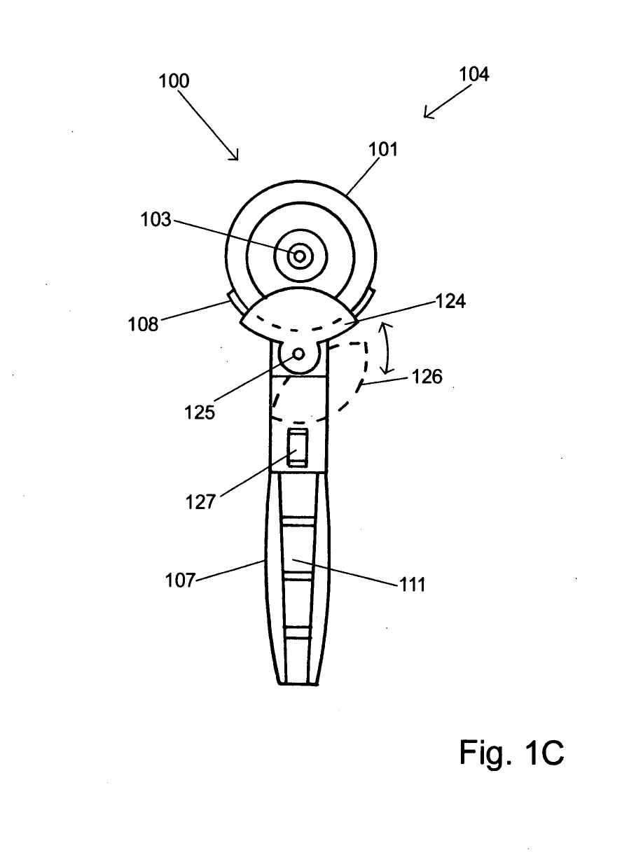

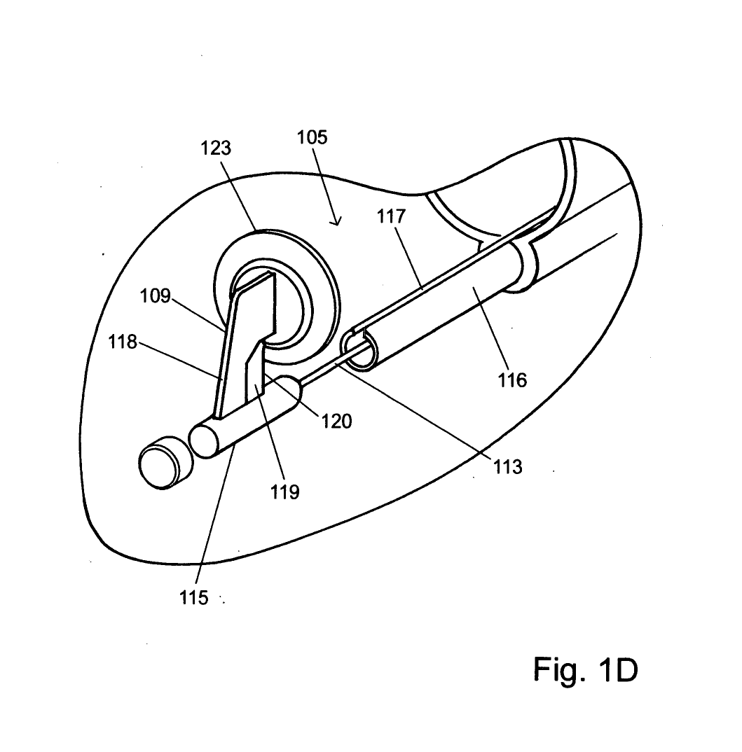

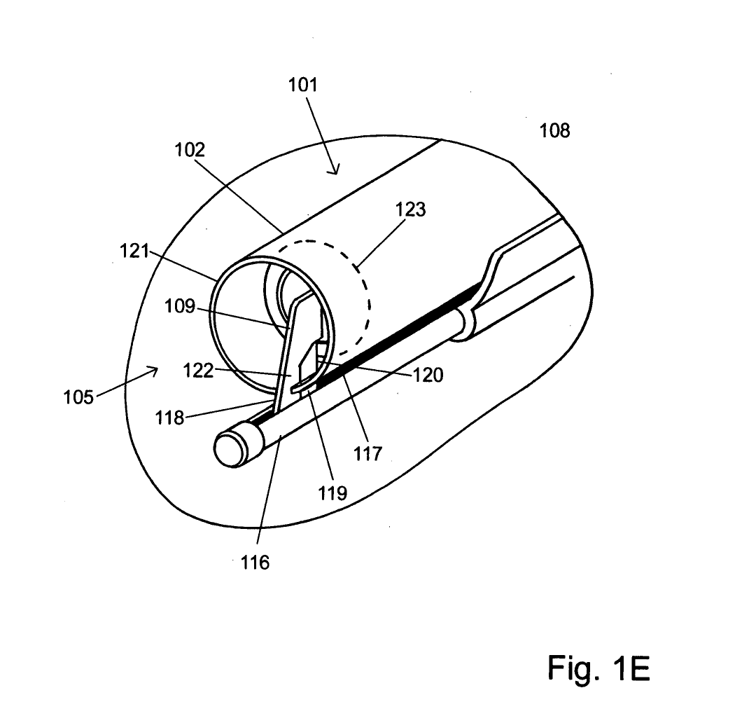

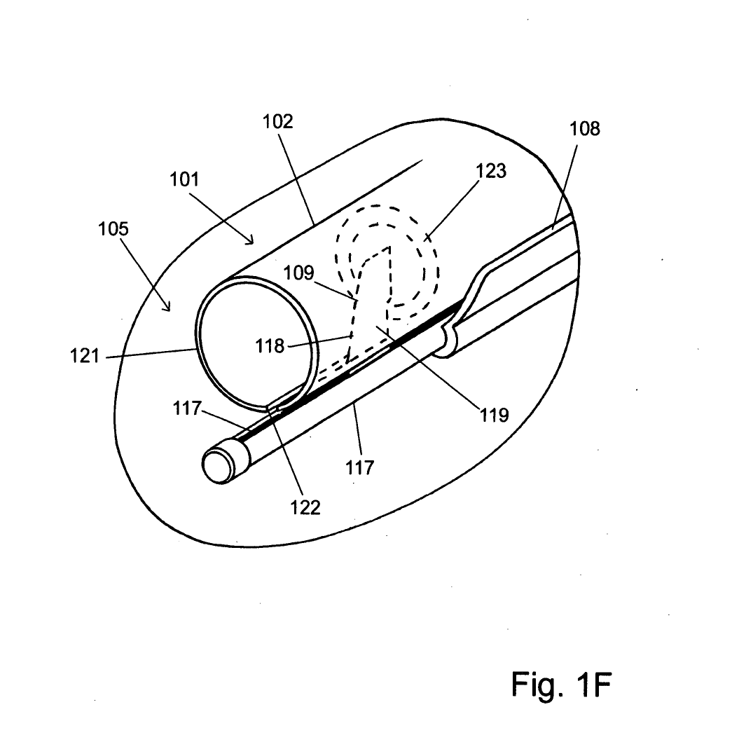

The dispenser 100 and the cartridge 101 shown in FIGS. 1A to 1F can be oriented with a longitudinal centerline L generally forming an axis of the cartridge 101 as shown in FIG. 1A. The term “longitudinal” refers to a line, axis, or direction in the plane of the cartridge 101 that is aligned with the centerline L. The dispenser 100 and cartridge 101 can further be oriented with a transverse (or lateral) centerline T that is perpendicular to the longitudinal centerline L as shown in FIG. 1B. The term “transverse” refers to a line, axis, or direction in the plane of the dispenser 100 and cartridge 101 that is aligned with the centerline T. The term “transverse” can generally correspond to the direction associated with the width dimension of the dispenser 100 and the cartridge 101. The dispenser 100 and cartridge 101 can further be oriented with a line Z as shown in FIGS. 1A and 1B which is perpendicular to the plane formed by centerlines L and T and generally corresponds to the direction associated with the height dimension of the dispenser 100.

The length of the dispenser 100 and the cartridge 101 is the maximum dimension measured parallel to the longitudinal centerline L in the longitudinal direction. The width of the dispenser 100 and cartridge 101 is the maximum dimension measured parallel to the transverse centerline T in the transverse direction. The height of the dispenser is the maximum dimension measured parallel to the Z axis.

When a range or interval is disclosed, the disclosure is intended to disclose both the endpoints and the intervals within the range. For example, a range of 0.005 to 0.010 includes 0.005, 0.006 and 0.010 within that range.

FIG. 1A shows a dispenser 100 with a cartridge 101 loaded in the dispenser 100. The cartridge 101 for use with the dispenser 100 can be a standard one used for caulks, adhesives, sealants, and other flowable substances. The cartridge 101 can include a tube 102 pre-filled with the flowable substance (not shown). The cartridge 101 can have a nozzle 103 on the front end 104. The flowable substance can be sealed in the cartridge tube 102 by a frangible seal (not shown) on the front end 104 of the tube 102 and a cartridge piston 106 inside the tube 102 near the back end 105 of the cartridge 101.

The dispenser 100 can be manufactured to accommodate a standard cartridge 101. The tube 102 can have a length of approximately 8.5 in. The nozzle 103 can extend approximately 2.75 in., making the entire length from the back end 105 to the tip of the nozzle 103 approximately 10.25 in. The typical cartridge 101 can be filled with 10.1 fl. oz. (300 ml) of a flowable substance (not shown). However, the dispenser 100 can readily be manufactured to accommodate cartridges 101 that are smaller or larger.

The dispenser 100 can preferably have a handle 107, a cradle 108 for holding the cartridge 101, a pusher 109 for moving the cartridge piston 106, and a drive mechanism 110 for advancing the pusher 109. The drive mechanism 110 can include a trigger 111, a winch 112, a cable 113, and pulleys 114. The cable 113 can be connected on a first end to the winch 112 and to the pusher 109 on the other end. The trigger 111 can function as the lever of the winch 112 and can turn the winch 112.

The pusher 109 can preferably have a slider 115 that connects to the cable 113 as shown in the exploded view of FIG. 1D. The slider 115 can fit in a guide 116. The guide 116 can run the length of the cartridge tube 102 when the cartridge 101 is loaded in the dispenser 100. The guide 116 can also have a slot 117 that runs the length of guide 116. A connecting member 118 can slide along the slot 117 and connect the slider 115 to the the pusher 109. In addition, the connecting member 118 can have cutter 119 on its front side as shown in FIG. 1D.

The cutter 119 can form a sharp front edge 120. The front edge 120 should be sufficiently sharp to cut the wall 121 of the cartridge tube 102. The cutter 119 should be sufficiently durable to repeatedly cut the wall 121 of multiple cartridge tubes 121.

The cutter 119 and the connecting member 118 as a whole can be made of or coated with a material that discourages adhesion of materials such as caulks or adhesives. Material from the cartridge 101 may contact the pusher 109 and especially the connecting member 118 and the cutter 119. Having a non-stick surface on these components can make cleanup easier.

The dispenser 100 can be used as follows. A user can grip the handle 107 with one hand (not shown). The user can squeeze the trigger 111 with her or his fingers (not shown). The trigger 111 can turn the winch 112 causing the cable 113 to wind around the winch 112. The cable 113 can be drawn through the pulleys 114 and draw the slider 115 forward in the guide 116 and thereby advance the pusher 109. As shown in FIG. 1E, as the pusher 109 moves forward, the cutter 119 can cut the wall 121 of the cartridge tube 102. The cut in the wall 121 of the tube 102 forms a seam 122.

As the pusher 109 continues to advance with successive pulls of the trigger 111, the face 123 of the pusher 109 can eventually contact the cartridge piston 106. (The trigger 111 can be spring loaded (not shown) making successive pulls easier). With each further advance of the pusher 109, the cutter 119 can lengthen the seam 122, the pusher 109 can push the cartridge piston 106 forward, and the pressure created by the advancement of the cartridge piston 106 can expel caulk from the nozzle 103.

The front end 104 of the dispenser 100 can have a retainer 124 as shown in FIG. 1C. The retainer 124 can resist the forward pressure of the pusher 109. In this embodiment, the retainer 124 can preferably swing on a pivot 125. FIG. 1C shows the retainer 124 in a second position 126. In this second position 126, the cartridge 101 can be removed from the dispenser 100 by pulling forward on the front end 104 of the cartridge 101 or the nozzle 103. This can be advantageous when removing a spent cartridge 101. The cartridge 101 can be pulled forward and extracted from the dispenser 100.

The dispenser 100 can use a ratcheting mechanism that generally resembles ratcheting mechanisms used in prior art devices of various kinds including “come-alongs.” FIG. 1A shows a release lever 127. The release lever 127 can work in conjunction with the trigger 111. When engaged, the release lever 127 can allow a pull of the trigger 111 to advance the winch 112 in a clockwise direction. When engaged, the release lever 127 can also prevent the winch 112 from turning in a counterclockwise direction after the trigger 111 has been pulled and then released.

The release lever 127 can also be disengaged. When the release lever 127 is disengaged, the winch 112 can rotate freely in a clockwise 128 or counterclockwise direction 129. The release lever 127 can be spring loaded (spring not shown) to ensure that the release lever remains engaged unless a user purposely moves the release lever to a disengaged position (not shown).

The release lever 127,can typically be used in two instances. First the release lever 127 can be disengaged when the user wishes to relieve pressure against the cartridge piston 106. For example, when dispensing a relatively thick material such as caulk, each advance of the pusher 109 can build up substantial pressure against the cartridge piston 106. This can cause caulk to flow out the nozzle 103 some time after a pull of the trigger 111. Disengagement of the release lever 127 can immediately relieve the pressure and can prevent the caulk (or other substance) from continuing to flow.

Second, the release lever 127 can be disengaged after the cartridge 101 has been removed from the dispenser 100. Once disengaged, the pusher 109 can be pulled by the user back to its starting position at the back end 105 of the guide 116 in preparation for use of another cartridge 101.

The dispenser 100 and its components can be made of many different materials. For example, many of the components can be made of metals such as steel or aluminum; plastics; or composites such as carbon fiber or fiberglass. The materials can be formed or fabricated in various ways. For example, components can be stamped, cut, cast, molded, and so forth. Other materials and other forming processes may also be suitable.

The dispenser 100 according to the first embodiment can offer many advantages. First, the dispenser 100 can have a shorter length when the dispenser 100 is loaded with a fresh cartridge 101 than the prior art dispensers. A typical prior art dispenser with its push rod fully extended can be well over twenty inches from the back end of the push rod to the tip of the nozzle 103. This length is necessary because the push rod of a prior art dispenser must be of sufficient length to travel nearly the entire length of the cartridge tube 102 when the caulk is dispensed. In addition, the back end of the push rod typically remains outside the tube 102 when the caulk has been fully dispensed so that the user can grasp the back end of the push rod in order to pull the push rod back for removal of a spent cartridge 101. This adds additional length.

In contrast, the dispenser 100 can have a length well under twenty inches from the back end 105 to its front end 104 when intended for use with a standard caulk cartridge 101. In fact, for most applications the length from the back end 105 to the front end 104 can be under ten inches (i.e., slightly longer than the length of a cartridge tube 102 of a standard cartridge 101). Generally, the length of the dispenser 100 can be shortened by having components that are stronger structurally. For example, a structurally strong guide 116, connecting member 118, and retainer 124 can minimize the overall length of the dispenser 100.

The shorter length of the dispenser 100 can have many benefits such as: the dispenser 100 can be more easily maneuvered in tight quarters such as in kitchens, bathrooms, and so forth; and the dispenser 100 can be constructed of less material making the dispenser 100 lighter and thereby cause the user less fatigue.

Second, the dispenser 100 can more easily accommodate a handle 107 whose location distributes weight more evenly between the front end 104 and the back end 105 of the dispenser 100. For example, as shown in FIG. 1A, the handle 107 can preferably be located approximately midway between the front end 104 and back end 105 of the dispenser 100 and midway between the front and back ends 104, 105 of the cartridge tube 102. The handle (not shown) on prior art dispensers, on the other hand, is typically located near the back end 105 of the cartridge tube 102. This position of the handle 107 on the dispenser 100 can make control of the nozzle 103 easier and can reduce fatigue.

Third the components of the drive mechanism 110 including the winch 112, pulleys 114, cable 113, and trigger 111 (functioning as the rotating lever of the winch 112) used in the dispenser 100 can work together to provide mechanical advantage. The level of mechanical advantage provided by the drive mechanism 110 can even be varied during manufacture to meet the demands of particular users. In other words, the drive mechanism 110 can be “geared” much like a single gear bicycle to meet the demands of the intended user. Some users may prefer easier but slower dispensing of the contents. A dispenser 100 with greater mechanical advantage or “lower gearing⇄ could accomplish this. For example, users doing more exacting finish work, users with smaller or weaker hands, or users dispensing viscous flowable substances may prefer a dispenser 100 with greater mechanical advantage. Other users may prefer harder but faster dispensing of the contents. A dispenser 100 with less mechanical advantage or “higher gearing” could accomplish this. Users working on large projects, users with stronger or larger hands, or users dispensing thinner flowable substances may prefer less mechanical advantage in their dispenser 100. The dispenser 100 can be manufactured to accommodate the level of mechanical advantage best suited for the user or the application.

Several aspects of the design of the drive mechanism 110 can influence the extent of mechanical advantage provided by the dispenser 100. For example, the diameter of the drum 130 of the winch 112 can affect the level of mechanical advantage provided by the winch 112. By increasing the diameter of the drum 130, the mechanical advantage can be increased. By decreasing the diameter of the drum 130, the mechanical advantage can be decreased.

The width of the drum 130 of the winch 112 can also affect the level of mechanical advantage provided by the winch 112. The power of the winch 112 decreases if the cable 113 exceeds one layer of cable 113 wrapped around the drum 130. Therefore a wider drum 130 can allow the drum 130 to handle a longer length of cable 113. This can minimize the number of layers of cable 113 wrapped around the drum 130 and thereby increase the mechanical advantage of the winch 112.

The length of the trigger 111 can have a substantial effect on the level of mechanical advantage provided by the winch 112. The trigger 111 can function as the lever of the winch 112. Generally, the longer the trigger 111, the greater the mechanical advantage provided by the trigger 111. Of course, the length of the trigger 111 should also be balanced against the demands for user ergonomics. A large handle 107 with a long trigger 111 may be uncomfortable for certain users.

Gearing, such as internal gearing (not shown) in the winch 112, can affect the level of mechanical advantage provided by the dispenser 100. Internal gearing can have generally the same effect as increasing the length of the trigger 111. By adding internal gearing, the level of mechanical advantage can be increased.

Finally, the configuration of the pulleys 114 can affect the mechanical advantage provided by the drive mechanism 110. Configuring the pulleys 114 to create a block and tackle (not shown), for example, can compound the mechanical advantage. However, the complexity of a block and tackle and the likely need for a larger sized dispenser 100 could make use of a block and tackle less preferable.

Many other embodiments can have still other features than those described above. Some of those other features or configurations are discussed below.

Other embodiments of the dispenser (not shown) can have drive mechanisms that differ from the drive mechanism 110 described above. For example, an alternative drive mechanism can be powered in different ways. The drive mechanism of an alternative embodiment, for example, can have an electric or fuel powered motor. The drive mechanism of an alternative embodiment can be powered by compressed gas. Compressed gas can be provided by a cartridge connected to an alternative dispenser or a compressor that hooks to the alternative dispenser via a hose.

Other embodiments (not shown) can have drive mechanisms that differ in other ways. For example, the cable 113 described above can be replaced with an elongated piece of flat spring steel that wraps around a winch. The drive mechanism 110 described above can be replaced with a continuous chain (or belt) drive system in which, for example, the chain is rotated around a sprocket. Many other embodiments can have other drive mechanisms that are different from those described above but are still within the scope of the invention.

Other embodiments can have a drive mechanism in a single dispenser that incorporates a range of gears (not shown). This could permit changing gears based on the application or the user's needs. For example, a user could employ a lower gear to apply thicker caulks. A user could employ a high gear for thinner materials. An embodiment employing multiple gears is within the scope of the invention.

Other embodiments can also have handles or triggers configured differently than those described above. An alternative dispenser powered by an electric motor (not shown), for example, can have a switch as opposed to the trigger 111 described above. An alternative manually powered dispenser could have a handle and trigger whose orientation in space is different the orientation described above in relation to FIGS. 1A to 1F. Many other embodiments can have other configurations for the handle or trigger (not shown) that are within the scope of the invention.

Other embodiments (not shown) can employ a pusher different from the pusher 109 and the components associated with it described above. For example, the slider 15 described above could be replaced with a wheel or gear that rolls along a track or rack. An alternative cutter could have a replaceable blade or could have more than one blade. An alternative cutter could use different actions such as having two blades that scissors together; could employ cutting wheels; or could saw the tube wall 121 instead of slicing it. These and other configurations of a pusher and its components in alternative embodiments are within the scope of the invention.

Other embodiments (not shown) could have different configurations for a cradle or a retainer. For example, a cradle (not shown) could wrap around all or a portion of the cartridge 101. A cradle and a retainer could be configured similar to a cradle for prior art dispensers. These and other configurations are within the scope of the invention.

Other embodiments (not shown) could employ a cartridge for use with a dispenser configured differently than the standard cartridge 101 described above. For example, an alternative cartridge (not shown) can have a longitudinally weakened portion. A cutter (even one with a relatively dull front edge) could split the alternative cartridge tube along the weakened portion. These and other configurations of an alternative cartridge and its components are within the scope of the invention.

### Modifications

The embodiments or examples discussed above can be combined in various ways without departing from the invention. Moreover, the present invention should not be considered limited to the particular examples described above, but rather should be understood to cover all aspects of the invention as fairly set out in the claims arising from this application. For example, while suitable sizes, materials, packaging and the like have been disclosed in the above discussion, it should be appreciated that these are provided by way of example and not of limitation as a number of other sizes, materials, fasteners, and so forth may be used without departing from the invention. Various modifications as well as numerous structures to which the present invention may be applicable will be readily apparent to those of skill in the art to which the present invention is directed upon review of the present specifications. The claims which arise from this application are intended to cover such modifications and structures.

We claim:

1. A device for dispensing flowable materials such as caulk comprising:
a. a cartridge including a piston slidably received therein for moving a flowable material out of a nozzle;
b. a dispenser having a rear end and a forward end comprising: a cradle for holding the cartridge with the nozzle positioned forward, a pusher for engaging the piston, and a drive mechanism for advancing the pusher forward, the drive mechanism having at least one fulcrum positioned forward of the pusher during operation of the dispenser.

2. A device for dispensing flowable materials such as caulk comprising:
a. a cartridge including a piston slidably received therein for moving a flowable material out of a nozzle;
b. a dispenser having a rear end and a forward end comprising: a cradle for holding the cartridge with the nozzle positioned forward, a pusher for engaging the piston, a cutter for cutting a slit in a wall of the cartridge, a carriage joined to the pusher and the cutter and slidably mounted on a guide, and a drive mechanism that moves the carriage forward on the guide, whereby the drive mechanism moves the carriage forward, cutting the slit, allowing the pusher to engage the piston through the slit.

3. A device for dispensing flowable materials such as caulk comprising: a drive mechanism having a winch for driving the dispensing of a flowable material from a cartridge.

4. The device of claim 1 wherein the fulcrum is an axis of a pulley.

5. The device of claim 1 wherein the fulcrum and a lever for the fulcrum are positioned forward of the pusher during operation of the dispenser.

6. The device of claim 1 comprising at least two fulcrums.

7. The device of claim 1 wherein the drive mechanism comprises a winch.

8. The device of claim 1 wherein the drive mechanism comprises a motor.

9. The device of claim 1 wherein a handle for grasping the dispenser is positioned in front of a rear end of the cartridge when the cartridge is held in the dispenser.

10. The device of claim 2 wherein the drive mechanism comprises a winch.

11. The device of claim 2 wherein the drive mechanism comprises a motor.

12. The device of claim 2 wherein a handle for grasping the dispenser is positioned in front of a rear end of the cartridge when the cartridge is held in the dispenser.

13. The device of claim 3 wherein the winch includes a ratcheting mechanism.

14. The device of claim 3 wherein the winch has at least two gears.

15. The device of claim 3 wherein the drive mechanism comprises a motor.
